(19) United States
(12) Patent Application Publication
(10) Pub. No.: US 2005/0169365 A1
(43) Pub. Date: Aug. 4, 2005

(54) Data encoding using multi-dimensional redundancies

(76) Inventor: Adam Leslie Clark, Melbourne (AU)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/770,432

(22) Filed: Feb. 2, 2004

(51) Int. Cl. H04N 7/12

(52) U.S. Cl. 375/240.01

(57) ABSTRACT

Data values are encoded by mapping multi-dimensional parameters thereof to respective one-dimensional parameters and creating a table of encoded data values in which the data values are represented by their respective encoded counterparts utilizing the one-dimensional parameters and in which redundant ones of the encoded data values share common table entries.

### FIELD OF THE INVENTION

The present invention relates to methods and systems for compressing data values which have one or more multi-dimensional parameters.

### BACKGROUND

Data compression is widely used in a variety of contexts for removing redundancies from data. Redundancies can come in a variety of forms, for example repeated bit or byte sequences, or, often, on larger scales. All data compression methodologies seek to transform one data representation into another, more compact representation for specific data sets.

Data compression techniques can be lossy or lossless. Lossless compression involves a transformation of the representation of a data set such that it is possible to reproduce exactly the original data set by performing a decompression transformation. Lossy compression is a representation that allows one to reproduce something that only approximates the original data set. Lossy compression techniques can frequently produce more compact data representations than lossless compression techniques can but are suitable only in instances where the literal bit-pattern of a digital file is not required.

Many examples of both lossy and lossless compression methods exist in the art. For example, run-length encoding (RLE) is a widely used lossless compression technique. RLE makes use of the fact that many data representations consist largely of strings of repeated bytes. Thus, rather than represent each character with its own byte, RLE simply replaces the original data set with an iteration count followed by the character to be repeated.

When it comes to very large data files, for example digital audio/video files, very sophisticated compression techniques have been developed. For example, the Motion Picture Experts Group (MPEG) has promulgated a number of interoperability standards that describe schemes for compressing and decompressing digital audio/video information for many applications. Likewise, the International Telecommunications Union (ITU) has published its own set of interoperability standards for audio/video compression.

Despite the variety of existing compression/decompression methodologies, however, there remains a problem in that these methodologies still do not provide sufficiently small files to be transported using low-bandwidth communication links in acceptable times. As a result, users that are limited to accessing resources such as Internet web servers via these low-bandwidth communication links often are unable to achieve satisfactory user experiences because download times for audio/video files are too long. Thus, there is a need for new data compression methodologies.

### SUMMARY OF THE INVENTION

In one embodiment, the present invention provides a scheme for encoding data values by mapping multi-dimensional parameters of the data values to respective one-dimensional parameters, and creating a table of encoded data values in which the data values are represented by their respective encoded counterparts utilizing the one-dimensional parameters and in which redundant ones of the encoded data values share common table entries.

### BRIEF DESCRIPTION OF THE DRAWINGS

The present invention is illustrated by way of example, and not limitation, in the figures of the accompanying drawings in which:

FIG. 1 illustrates an example mapping of a table raw data values having one or more multi-dimensional parameters into a table of encoded data values having only one-dimensional parameters in accordance with an embodiment of the present invention; and

FIG. 2 illustrates in further detail the mapping of a multi-dimensional parameter into a one-dimensional parameter in accordance with an embodiment of the present invention.

### DETAILED DESCRIPTION

Described herein is a method and system for encoding data values having one or more multi-dimensional parameters by mapping those parameters to respective one-dimensional parameters. These one-dimensional parameters may then be stored in a table of encoded data values in which their respective encoded counterparts represent the original data values. Redundant ones of the encoded data values, meaning those which are identical or sufficiently similar to one another, may share common table entries, for example by making use of pointers or other entries in the table. Decoding is accomplished by essentially reversing the encoding process with reference to certain reference data values.

The present methods and systems may be applied in a variety of contexts. For example, the present invention finds particular application in the field of video and/or audio encoding/decoding. Indeed, the present invention may be used in any application in which data values are represented by one or more multi-dimensional parameters, such as color, position, orientation, or other parameters. Accordingly, although the present invention will be described with reference to presently preferred embodiments, the reader should remember that the full scope of the invention should be measured only in terms of the claims that follow this description.

Throughout the following description, reference will be made to various algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention may be implemented by a general purpose or special purpose computer system configured (e.g., through the use of one or more computer programs) for performing the operations described herein. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus. The computer system may take on any desired configuration, including but not limited to a hand-held device, a multiprocessor system, a microprocessor-based or programmable consumer electronic device, a minicomputer, a mainframe computer, a personal computers, and the like. The invention can also be practiced in distributed computing environments where tasks are performed by remote processing devices that are linked through a communications network.

The present invention is not described with reference to any particular programming language because any of a variety of programming languages may be used to implement the teachings described herein. Furthermore, it is common in the art to speak of software, in one form or another (e.g., program, procedure, application, etc.), as taking an action or causing a result. Such expressions are merely a shorthand way of saying that execution of the software by a computer causes the processor of the computer to perform an action or produce a result.

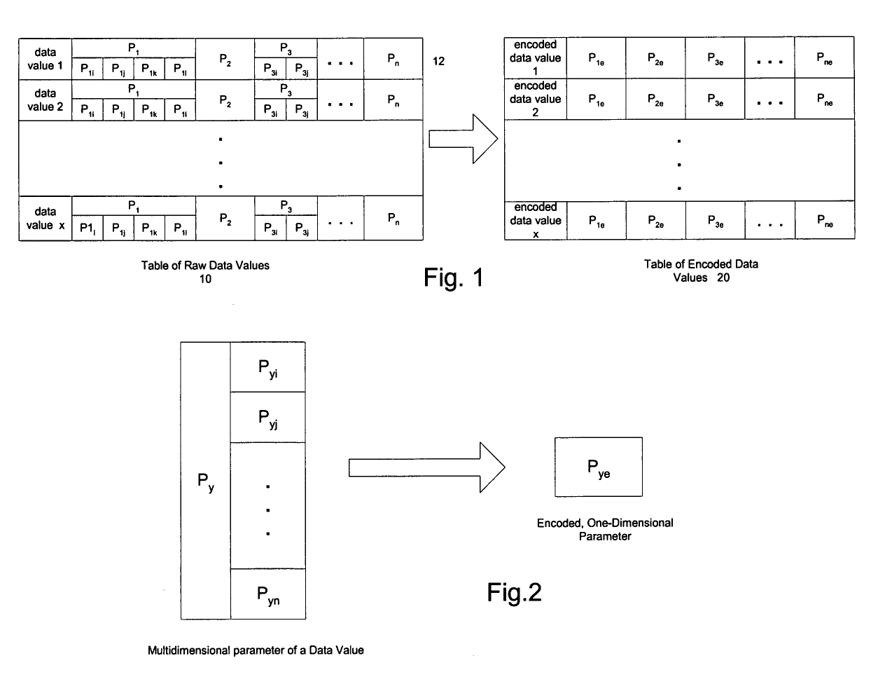

Turning now to FIG. 1, one embodiment of methods of the present invention are illustrated in a graphical fashion by the transformation of a table 10 of raw data values into a table 20 of encoded data values. The raw data values that make up table 10 may represent any digital information. Each data value has an associated row 12 of parameters (P) that describe the data value. For example, if the data values represent pixels of a frame of video information, the parameters may represent the color, luminance and chrominance information associated with the pixels. In general there are “x” data values and “n” parameters per data value in table 12, where x and n are integers.

Some of the parameters may be one-dimensional parameters, meaning that the entire parameter is described by a single value. Referring to the earlier example, in the case where the data values represent pixels of a frame of video information, the luminance and chrominance parameters may be one-dimensional parameters.

Other parameters, however, may be two-, three- or, generally, multi-dimensional in nature, meaning that more than one value is needed to describe the parameter. In the case of the data values representing pixels, the color parameter is, in general, multi-dimensional because typically more than one value is required to describe the parameter. For example, values for red, green and blue are often required in order to fully describe the color parameter of a pixel data value, making the color parameter three-dimensional in nature. Each dimension of a data value parameter may be represented as Pᵥₘ, where v represents the parameter number, m represents the sub-parameter number and both are integers.

In accordance with the present invention, the multi-dimensional parameters for each data value in table 10 are mapped to respective one-dimensional parameters in the table 20 of encoded data values. This is illustrated in detail in FIG. 2. A parameter P_{y} having a number of dimensions (or sub-parameters) P_{yi}, P_{jy}, . . . P_{yn} is mapped to a one-dimensional parameter P_{ye} to be used in table 20. This has the effect of reducing the total number of bits required to represent the data value, provided the mapping is something other than merely aggregating the values associated with the multi-dimensional parameter into a single value. By way of example, in the case of the pixel data values the original multi-dimensional color parameter (having red, green and blue dimensions say) may be mapped to a single color value (color) having a fewer number of bits than the aggregate of the red, green and blue values.

Of course any such mapping may be done in a variety of ways. In one embodiment of the present invention the mapping is done so as to describe a raw, multi-dimensional parameter solely in terms of its dominant constituent when encoded. For example, consider a raw pixel data value that has a color parameter with its red dimension equal to “rrr”, its blue dimension equal to “bbb” and its green dimension equal to “ggg” (where rrr, bbb and ggg are all integers). If the red dimension was the dominant value (e.g., in terms of its magnitude), then the resulting encoded version of this parameter might simply have a one-dimensional color parameter that indicated “red”, with perhaps some appropriate magnitude value that may or may not be the same as the raw pixel data value's red dimension. Indeed, if this technique is used in combination with a scaling of the magnitude of the dominant parameter constituent (or even a value which takes into account all or some of the sub-parameters values) to arrive at the encoded pixel parameter (P_{ye}) value, significant savings in terms of the number of bits required to represent the parameter (and, hence the data value as a whole) may be achieved.

Other ways in which the mapping may be performed include using a weighted dimension approach. That is, the values of the raw data value parameter dimensions may be separately weighted according to their individual impact on the overall parameter being described and then the weighted dimension value having the greatest magnitude selected as the dominant constituent. Alternatively, an averaging of the parameter dimension values (weighted or not) may be performed to arrive at the encoded, one-dimensional parameter value.

It should be noted that what is being proposed herein in not simply mapping an existing parameter to another parameter space in order to change the representation of that parameter. For example, this is not a proposal to simply map a color parameter initially described by RGB color components to YUV or another color space. Instead, the present invention involves making a deliberate decision to eliminate certain parameter information (e.g., color information) in order to develop a description of a data value that is smaller (e.g., in terms of the number of bits) than the original.

As the table 20 of encoded data values is being constructed, a further technique may be employed in order to further reduce the number of bits required to represent the original table of raw data values. In cases where the various parameter values of a newly encoded data value are identical or sufficiently similar (e.g., within a tolerance limit) to the values of a previously encoded data value's parameters, then this entire list of parameters need not be repeated within table 20. Instead, one need only store a pointer to the previously encoded data value as an indication that the same encoded parameter values should be used. Assuming the number of parameters is such that it requires fewer bits to represent the pointer than it does to represent the parameters themselves, this will further reduce the number of bits required to represent the data values in their encoded form. In some cases, it may be beneficial to use this approach for individual parameters (rather than for entire data values) within table 20, for example where a pointer can be represented in fewer bits than a parameter. Note that this portion of the encoding process is a lossless process, whereas other portions of the encoding process may be lossy in nature.

When employed as part of a data encoding/decoding scheme, the present methods allow for the transmission of the table 20 of encoded data values rather than the table 10 of raw data values between a transmitter and a receiver. Because the number of bits required to represent the encoded data value parameters is less than the number of bits required to represent the raw data value parameters, the present methods will achieve bandwidth savings during such transmissions. Viewed another way, the present methods allow for the use of lower bandwidth communication links to support such transmissions. This is especially useful when low-bandwidth communication links such as dial-up communication links (typically 14.4-56.6 kBps) and/or mobile phone (e.g., GSM, or CDMA) communication links (typically 9.6 kBps) are being relied upon to transport otherwise large data files, such as audio/video files.

In order to properly decode the table 20 of encoded data values at a receiver either of two methods may be employed. In a first method, a set of reference data values may be transmitted to the receiver along with the table 20 of encoded data values. These reference data values may include a small number of raw data values having a complete set of the multi-dimensional parameters. Using this information, the receiver may construct a table of decoded data values having multi-dimensional parameters for further use.

For example, in the case of data values representing pixels of video frames, a small number of reference pixel data values may be transmitted to the receiver. In one embodiment, reference pixels for red, green, blue and black (representing a maximum color intensity in each dimension) may be so provided. Each reference pixel includes a multi-dimensional color parameter; hence the “red” pixel will have RGB values, as will the green pixel, the blue pixel and the black pixel.

The receiver may construct a table of decoded pixel values by using the appropriate reference pixel and scaling the RGB values therefor as appropriate. For example, if the encoded data value recites a red pixel (meaning that during encoding the corresponding raw pixel was determined to have a dominant red dimension color parameter) then the receiver would use the RGB values for the red reference pixel (perhaps scaled according to the magnitude of the color parameter for the encoded data value) in creating the corresponding entry for the pixel of interest in the table of decoded data values.

The second method for decoding the table 20 of encoded data values involves providing the receiver with prior knowledge of the encoding process used. That is, if the receiver is provided with information similar to that which could be obtained using the reference data values prior to receiving the transmitted table of encoded data values, then the transmission need not include the reference data values in order to decode the information included in the table. Such knowledge may be provided in a variety of forms, including a lookup table at the receiver.

This use of a lookup table also has application to the encoding process. For example, if the encoder is provided with a sufficiently large lookup table that encompasses all or a large number of the possible combinations of data value parameter sets likely to be encountered in encoding operations, then encoding becomes a simple matter of translating the data value to a pointer that references the appropriate lookup table entry. If the receiver is provided with a similar lookup table then decoding is performed by mapping the pointer from the table of encoded data values to the appropriate lookup table entry and using the indicated set of data value parameters. This approach can be combined with the above described method for reducing the number of encoded data value table entries using pointers to/from redundant ones thereof to even further reduce the amount of data included in the table.

It should be apparent that the present methods (with the exclusion of the encoder and decoder lookup table-based approach discussed immediately above) for encoding/decoding data values is a “lossy” process in that some of the original information for multi-dimensional parameters is destroyed as part of the encoding process. However portions of the process (e.g., the use of pointers within tables) are “lossless”. Thus, the present technique may not be suitable for all applications. Nevertheless, where perfect reproduction of an original data set is not required, the present methods may be employed to dramatically reduce the volume of data to be transmitted between an encoder and a decoder or to be stored in a data archive.

Thus, a method and system for encoding data values having one or more multi-dimensional parameters has been described. Although the present invention was discussed with reference to presently preferred embodiments, the full scope of the invention should be measured only in terms of the claims that follow.

1. A method, comprising encoding data values by mapping multi-dimensional parameters of the data values to respective one-dimensional parameters and creating a table of encoded data values in which the data values are represented by their respective encoded counterparts utilizing the one-dimensional parameters and in which redundant ones of the encoded data values share common table entries.

2. The method of claim 1, wherein the data values comprise pixel information.

3. The method of claim 1, wherein the data values comprise position information.

4. The method of claim 1, wherein redundant encoded data values share identical parameter values.

5. The method of claim 1, wherein redundant data values share parameters values which are similar to one another within a tolerance range.

6. The method of claim 1, further comprising transmitting the table of encoded data values to a receiver.

7. The method of claim 6, further comprising decoding the table of encoded data values at the receiver using the table of encoded data values and a set of reference information.

8. The method of claim 7, wherein the reference information is transmitted together with the table of encoded data values.

9. The method of claim 7, wherein the reference information is stored at the receiver prior to the transmission of the table of encoded data values.

10. The method of claim 7, wherein the reference information comprises a lookup table.

11. A method, comprising encoding a data values having one or more multi-dimensional parameters by combining a lossy encoding process in which the one or more multi-dimensional parameters of the data values are mapped to respective one-dimensional parameters and stored in a table of encoded data values, with a lossless encoding process in which redundant ones of the encoded data values are arranged to share common entries in the table.

12. The method of claim 11, wherein the data values comprise pixel information.

13. The method of claim 11, wherein the data values comprise position information.

14. The method of claim 11, wherein the redundant ones of the encoded data values share identical parameter values.

15. The method of claim 11, wherein the redundant ones of the encoded data values share parameters values which are similar to one another within a tolerance range.

16. The method of claim 11, further comprising transmitting the table of encoded data values to a receiver.

17. The method of claim 16, further comprising decoding the table of encoded data values at the receiver using the table of encoded data values and a set of reference information.

18. The method of claim 17, wherein the reference information is transmitted together with the table of encoded data values.

19. The method of claim 17, wherein the reference information is stored at the receiver prior to the transmission of the table of encoded data values.

20. A set of computer readable instructions embodied on a computer-readable medium, which when executed by a computer processor cause the computer processor to execute a process comprising encoding data values by mapping multi-dimensional parameters of the data values to respective one-dimensional parameters and creating a table of encoded data values in which the data values are represented by their respective encoded counterparts utilizing the one-dimensional parameters and in which redundant ones of the encoded data values share common table entries.
